(19) United States
(12) Patent Application Publication
(10) Pub. No.: US 2026/0260087 A1
(43) Pub. Date: Sep. 3, 2026

(54) PASSIVE MICRO-RFID TAG ANTENNA WITH IONIC ENCASEMENT THAT EXTENDS READ-DISTANCE-TO-SIZE RATIO

(71) Applicant: Somark Group Ltd., San Diego, CA (US)

(72) Inventors: Paul Donohoe, San Diego, CA (US); Brad D. Pedersen, Hayward, WI (US); Simon Morton, San Diego, CA (US)

(21) Appl. No.: 18/876,869

(22) PCT Filed: Jul. 10, 2023
(86) PCT No.: PCT/US2023/069855

§ 371 Date: Dec. 19, 2024

Related U.S. Application Data
(60) Provisional application No. 63/359,637, filed on Jul. 8, 2022.

(51) Int. Cl. G06K 19/077; H01Q 1/22; H01Q 7/00; H01Q 9/26

(52) U.S. Cl. CPC G06K 19/07754; G06K 19/07786; G06K 19/0779; H01Q 1/2225; H01Q 7/00; H01Q 9/26

(57) ABSTRACT

A passive micro-RFID tag provides for increased read effectiveness due to an ionic encasement of the micro-RFID tag antenna. In various embodiments, the ionic encasement may comprise embedding, encapsulating, or coating the tag in a non-biological medium which exhibits conductive ionic properties. In embodiments, the micro-RFID tag having a maximum length dimension of 12 mm can be read with at least 90 percent effectiveness by a 30 dB RFID tag reader at least 48 cm away from the micro-RFID tag, thus providing a read-distance-to-size ratio of at least 4,000:1.

### CROSS-REFERENCE TO RELATED APPLICATION(S)

This is a 371 application based on PCT/US2023/069855, filed Jul. 10, 2023 and claims the benefit of provisional application No. 63/359,637, filed Jul. 8, 2022, the entire contents of which are incorporated herein by reference.

### FIELD OF THE INVENTION

The present disclosure relates generally to radio frequency identification (RFID) tags. More particularly, the present disclosure relates to a passive micro-RFID tag antenna that is configured with an ionic encasement to extend the read-distance-to-size ratio.

### BACKGROUND OF THE INVENTION

A passive radio-frequency identification (RFID) tag may be used to mark/identify an animal or an object. In certain situations, it is desirable for such passive RFID tags to be small as possible, for example, reducing discomfort of the RFID tag to the animal, the observability of the RFID tag on an object, and/or the cost of the RFID tag. Passive RFID tags are powered by an externally generated electromagnetic wave in the form of an interrogation radio wave. Such RFID tags have a radio receiver that receives the interrogation radio wave and a radio transmitter that transmits a radio wave comprising identification information in response to the received interrogation radio wave.

The read distance of an RFID tag antenna is determined by well-known and documented properties of an RFID system, including the signal frequency, radio frequency power level, the distance of the tag antenna from the radio receiver as the source of the radio signal (herein referred to as the reader) and most importantly, the length or surface area of the RFID tag antenna itself. In the context of this specification, the passive RFID tag antenna may resonate at certain known frequencies used for these kinds of devices, for example. Low Frequency (LF) (such as 125 to 135 Khz), High Frequency (HF) (such as 13.56 Mhz) or Ultra High Frequency (UHF) (860-928 Mhz).

Given limits to the power level that can be used for passive RFID tags, different techniques and configurations have been developed to extend the read distance of a passive RFID tag of a given size. Most of these developments have focused on using techniques that extend the antenna length within a constrained space, such as creating antenna forms based on meanders or even fractals. However, if a small tag is required, the attendant reduction in the length of the antenna necessarily attenuates the signal strength returned to the reader, and therefore the read distance.

In the context of this specification, a micro-RFID tag is defined as a small tag with maximum dimensions of 12 mm or less in length and 2.5 mm in diameter or width. Commercially available small micro-RFID tags can be as small as 5 mm×5 mm, but only provide a read distance of 0.5 cm in air.

Most implantable passive micro-RFID tags for animals are in the form of a rigid capsule of a non-conductive material like glass. Examples of these kinds of animal implantable passive RFID tags are shown in U.S. Pat. Nos. 4,262,632, 5,211,129, and 6,974,004, and U.S. Publ. Appl. No. US 2008/0042849 A1. Unfortunately, both the size and rigid nature of these kinds of passive micro-RFID tags in a capsule make implantation difficult, painful, and even ineffective, particularly when implanted in rodents or smaller animals.

One solution to these problems of capsule-based passive RFID tags is provided by the microelectronic animal identification tags developed by the assignee of the present disclosure as the RFAi.D™ tag, various aspects of which are described in U.S. Pat. No. 11,240,992, and as the Somark Digitail™ tag, various aspects of which are described in U.S. Pat. No. 11,392,816. These implantable passive micro-RFID tags are relatively flexible and can be in the form of a 6 mm long by 0.5 mm wide UHF RFID tag with a dipole, folded antenna that has various improvements in the antenna design that provide for increased effectiveness and read distances.

The maximum distance that a passive micro-RFID tag may be read is dependent on the frequency of the radio wave, the medium through with the radio wave is propagated, the power of the interrogation radio wave, and the size and design of the RFID tag antenna. The power of the interrogation radio wave for an implantable passive micro-RFID tag is typically limited by regulation in the context of animal research and experimentation to about 30 dB. Conventional approaches to improving RFID antenna design as described in RFID Tag Antenna Design, IMPINJ Whitepaper Ver. 1.0 (2017) can include increasing the size of the antenna by increasing the length of a meander type antenna or modifying the inductive loop that couples the antenna to the RFID chip.

In the context of the significant size constraints imposed for a passive micro-RFID tag, and with the complex characteristics of the medium through which the radio waves are propagated in this context, these conventional solutions for improved antenna design to increase read effectiveness of the passive micro-RFID tag are not predictable. Accordingly, there is an opportunity to improve on the design of this kind of relatively flexible, passive micro-RFID tag in terms of improved read effectiveness.

### SUMMARY OF THE INVENTION

A passive micro-RFID tag in accordance with embodiments as disclosed provides for increased read effectiveness due to an ionic encasement of the micro-RFID tag antenna. In various embodiments, the ionic encasement may comprise embedding, encapsulating, or coating the tag in a non-biological medium which exhibits conductive ionic properties. In embodiments, the micro-RFID tag having a maximum length dimension of 12 mm can be read with at least 90 percent effectiveness by a 30 dB RFID tag reader at least 48 cm away from the micro-RFID tag, thus providing a read-distance-to-size ratio of at least 4,000:1.

In various embodiments, the ionic encasement may comprise a non-biologic medium in the form of a conductive ionic polymer, a conductive ionic gel, or a combination of these non-bio logic mediums. In various embodiments a thickness of the ionic encasement may range of 0.1 mm to 1.0 mm, depending upon the electric and physical properties of the antenna and antenna circuit and the resonant frequency of the interrogation radio wave. Instead of trying to use a skin effect of electrical current along the skin boundary to potentially enhance the electrical current to the antenna as suggested by U.S. Pat. No. 11,392,816, the current disclosure utilizes the ions within the ionic encasement as a mechanism that is believed to be responsible for boosting the read-distance-to-size ratio.

In some embodiments, the non-biological medium comprises a conductive ionic polymer, such as poly(3,4-ethylenedioxythiophene): poly(styrenesulfonate) (PEDOT: PSS) or a conductive silicone. In some embodiments, the non-biological medium comprises a gel containing electrolytes with ionic components, such as sodium and, or chloride, which confer conductive properties to the gel.

In various embodiments, a passive UHF micro-RFID tag is comprised of an elongated flexible substrate having a pair of opposed surfaces with a RFID chip positioned on a first of the opposed surfaces. The RFID chip is directly electrically connected to a closed-loop multi-layer folded dipole antenna that is disposed on both opposed surfaces of the substrate. The antenna is electrically connected to the RFID chip and includes at least an inductor as part of the closed-loop antenna. In some embodiments, the ionic encasement and/or portions of the RFID tag not covered by the ionic encasement may be provided with an outer biocompatible insulative coating having a maximum thickness of up to 50 μm.

In other embodiments, a passive RFID tag is comprised of an encapsulating capsule surround and LF or HF RFID tag with the capsule being filled, for example, by injection with a conductive gel as the ionic encasement of the RFID tag.

In some embodiments, a passive RFID tag is provided with an ionic encasement that connects with an antenna of a LF or HF RFID tag for use with larger animals, for example, having a minimum length dimension of at least 10 cm can be read with at least 90 percent effectiveness by a 30 dB RFID tag reader at least 50 cm and up to 0.5 m away from the RFID tag, thus providing a read-distance-to-size ratio of at least 5,000:1.

In other embodiments, a passive RFID tag is arranged such that the non-biological medium of the ionic encasement in which the RFID tag is embedded is in the form of a container, such as a small vial or petri-dish, or in the form of a matrix made of a conductive polymer that constrains the non-biological medium, such as a gel, within the container or matrix.

In other embodiments, a passive RFID tag is arranged such that the non-biological medium of the ionic encasement in which the RFID tag is embedded is in the form of a wearable device made of conductive silicone.

### BRIEF DESCRIPTION OF THE FIGURES

FIG. 1 illustrates a perspective representation of an embodiment of an RFID tag with an ionic encasement,

FIG. 2A illustrates a cross-sectional side view of an RFID tag with a complete ionic encasement.

FIG. 2B illustrates a cross-sectional side view of an RFID tag with a partial ionic encasement.

FIGS. 3A and 3B illustrate a lengthwise mid-point cross-sectional view of an RFID tag positioned within a 21 AWG needle and a 21.5 AWG needle, respectively.

FIGS. 4A, 4B, and 4C illustrate configurations of an antenna layer of the antenna in different embodiments.

FIG. 5A illustrates a cross-sectional side view of an embodiment of an RFID tag with a closed-loop multi-layer folded dipole, an RFID chip on a first surface of the RFID tag substrate and a matching circuit on a second surface of the RFID tag substrate,

FIG. 5B illustrates a cross-sectional side view of an embodiment of an RFID tag with a closed-loop multi-layer folded dipole, an RFID chip on a first surface of the RFID tag substrate and a pair of inductors on the first surface of the RFID tag substrate.

FIG. 6 illustrates an idealized electrical schematic of an embodiment of an antenna matching circuit.

FIGS. 7A, 7B, and 7C are schematic depictions showing a sequence of steps for an embodiment of implantation of a RFID tag in the tail of a rodent.

### DETAILED DESCRIPTION OF THE EMBODIMENTS

Disclosed herein is an improved passive RFID tag configured for implantation in an animal, such as in a tail of a rodent or a small animal. Embodiments disclosed herein provide for increased read distances and identification effectiveness. In various embodiments, an RFID tag includes an elongated flexible substrate having a pair of opposed major surfaces: a first surface and a second surface with an RFID chip is mounted on one of the surfaces. In various embodiments, an ionic encasement may comprise embedding, encapsulating, or coating a portion or all the RFID tag in a biocompatible, non-biological medium which exhibits conductive ionic properties. In some embodiments, the non-biological, medium comprises a conductive ionic polymer or a conductive silicone. In some embodiments, the non-biological medium comprises a conductive ionic gel such as a hydrogel. In some embodiments, the non-biological medium comprises both a conductive polymer or silicone material and a conductive ionic gel.

In various embodiments, the RFID chip is directly electrically connected to a closed-loop multi-layer folded dipole antenna that is disposed on both opposed surfaces of the substrate. In various embodiments, RFID tag also includes one or more matching circuits arranged on one or both opposed surfaces that include at least an inductor. In various embodiments, the RFID chip is configured to operate in the ultra-high frequency (UHF) range. In other embodiments, the RFID chip is configured to operate in the low frequency (LF) range or high frequency (HF) range.

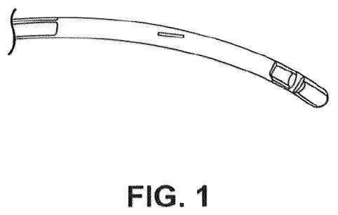

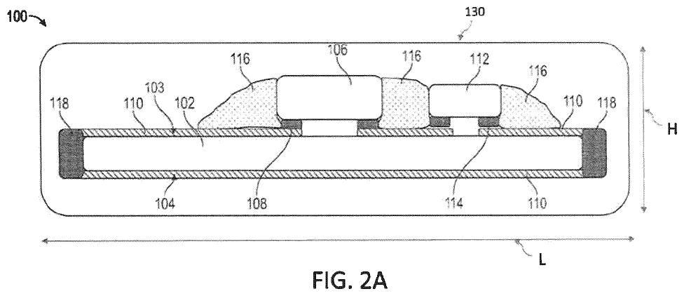

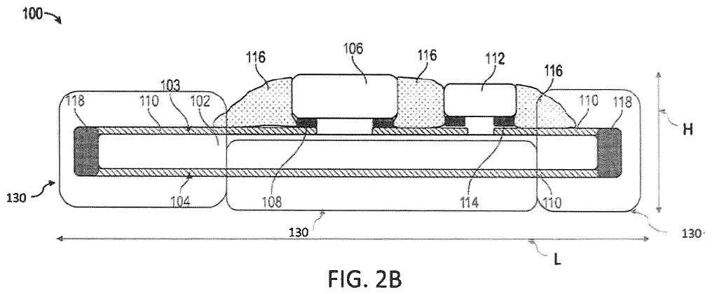

As shown in FIG. 1 and FIGS. 2A and 2B, embodiments of an RFID tag 100 include an elongated flexible substrate 102 having a pair of opposed major surfaces: a first surface 103 and a second surface 104. Flexible substrate 102 provides a dielectric support structure for RFID chip 106 and antenna 110. In various embodiments, an RFID chip 106 is mounted on the first surface 103. In some embodiments, the RFID chip 106 is directly electrically connected by a pair of solder pad joints 108 to a closed-loop multi-layer folded dipole antenna 110 that is disposed on both opposed surfaces 103, 104 of substrate 102.

In embodiments, RFID tag 100 is coated with a biocompatible non-biological conductive ionic encasement 130 having a maximum thickness of 0.1 mm to 1.0 mm covering a portion or all the RFID tag 100. In various embodiments, the ionic encasement 130 may comprise a non-biologic medium in the form of a conductive ionic polymer, a conductive ionic gel, or a combination of these non-biologic mediums. In various embodiments a total height (H) of the RFID tag 100 with the ionic encasement 130 may range from 0.1 mm to 1.0 mm, depending upon the electric and physical properties of the antenna and antenna circuit and the resonant frequency of the interrogation radio wave.

In some embodiments, the non-biological medium comprises a conductive ionic polymer, such as poly(3,4-ethylenedioxythiophene): poly(styrenesulfonate) (PEDOT: PSS) or a conductive silicone. In some embodiments, the non-biological medium comprises a gel or agar containing electrolytes with ionic components, such as sodium and, or chloride, which confer conductive properties to the gel. In some embodiments, the non-biological medium comprises polyurethanes and thermoplastic elastomer (TPE) having an ionic active ingredient/materials such as graphene, carbon black and/or silver nanoparticles.

In some embodiments, the gel may be constrained by a polymer matrix, such as a 3D printed thermoplastic polyurethane (TPU) frames with various geometries that may be injected with ionic conductive polyacrylamide (PAAm) based hydrogels to create durable, robust soft ionic encasements. In some embodiments, such encasements may also be utilized as mechanical sensors for detecting strain, pressure, and bending through changes in the electrical resistance of the ionic hydrogel as described, for example, in Payandebjoo, B. et. al. “Embedding ionic hydrogel in 3D printed human-centric devices for mechanical sensing,” Journal of Manufacturing Processes, Volume 100, 2023, Pages 1-10, ISSN 1526-6125, available on the Internet at <https://doi.org/10.1016/j.jmapro.2023.05.017>, the disclosure of which is hereby incorporated by reference,

In some embodiments, the ionic encasement 130 is applied directly to the RFID tag 100. In other embodiments, an insulative coating 132 is applied between the ionic encasement 130 and the RFID tag 100. In embodiments, the insulative coating 132 is a Parylene C coating that is applied by a tumble coating process to the completed tag. In other embodiments, the insulative coating 132 is a silicon or similar non-conductive biocompatible coating that is sprayed onto RFID tag 100 once the tag is assembled.

In embodiments, RFID tag 100 may also include a matching circuit 112 including at least an inductor electrically coupled in series with the antenna 110. In FIGS. 2A and 2B, matching circuit 112 is a surface mount device (SMD) component having an inductive element and a resistive element and is electrically connected to antenna 110 by a pair of solder pad joints 114.

In embodiments, RFID chip 106 and matching circuit 112 are further secured to the RFID tag 100 by a bioinert adhesive or potting material 116, such as an ultraviolet light curable adhesive available from Dymax. In addition to providing further structural integrity, the use of an adhesive material 116 can also reduce the exposed edges of RFID chip 106 and SMD matching circuit chip 112 to provide a more tapered or smoother interface between the exterior of the RFID tag 100 and the animal tissue. This can reduce abrasion, adhesions, inflammation, and infection that might otherwise be initiated as a physiological reaction to the needle implantation of the RFID tag 100.

Flexible substrate 102 can comprise a dielectric polyimide material, such as Kapton™ by DuPont. In embodiments, flexible substrate 102 has a maximum thickness of 100 μm and a dielectric constant in the range of 2.75-3.5. Flexible substrate 102 includes a first major surface 103 arranged on what may be referred to as a top or upper portion of flexible substrate 102. As depicted in FIG. 2B, flexible substrate 102 also includes a second major surface 104 arranged on what may be referred to as a bottom or lower portion of flexible substrate 102 such that first surface 103 is opposite second surface 104. In embodiments, at each end of the length dimension of flexible substrate 102, an upper portion of antenna 110 and a lower portion of antenna 110 are electrically connected by soldered ends 118.

In embodiments, flexible substrate 102 is configured to have a length L of between 4-10 mm. Length L may be determined based on a variety of factors. For example, one parameter of length L may be the intended RFID transmission wavelength, such that an effective length of the antenna 110 is close to a whole fraction of the intended RFID transmission wavelength. In embodiments, the effective length may be adjusted based on the changes in wavelength of the signal propagating through the tissue of the rodent because that wavelength is smaller than that of the same signal travelling in free space. In embodiments, the dimensions of the antenna 100, including the length and width are configured to match a resonant frequency/wavelength fraction of this reduced wavelength more closely to increase the read range.

Another parameter of length L may be the type of animal that RFID tag 100 is intended to be implanted. For example, smaller rodents, such as mice, have typical tail lengths that are more readily suited for RFID tags 100 having a length L of around 4-6 mm. In larger rodents, such as rats, the length L of RFID tag may be up to 10-12 mm. Increasing the length L can result in some improvements in the read strength and read effectiveness of the RFID tag 100 but can also impact the ease and effectiveness of needle implantation as well as the structural viability and integrity of the RFID tag 100.

In embodiments, a parameter of length L may include whether the length for a given flexibility of the RFID tag 100 interferes with the ability of the animal to curve the portion of its tail into which the RFID tag 100 is implanted without impacting the structural or electrical integrity of the RFID tag 100. In embodiments, the elongated flexible substrate 102 is configured to form a curved are between the pair of opposed ends of the substrate 102 that can be up to a curve defining a 45-degree are angle without producing more than a ten percent failure rate of the RFID tags 100 during a representative sample of initial flat bend testing (without rotational flex) after manufacture. In embodiments, the flexibility and structural integrity of the RFID tag 100 are influenced by the material and thickness of the substrate 102, the material and thickness of each layer of the antenna 100, the size of the solder pads 114 and formulation of the corresponding solder used, and the size of the RFID chip 106 and SMD matching circuit 112.

In various embodiments, RFID chip 106 is a passive-type RFID chip that does not include a battery. RFID chip 106 includes an integrated circuit and a transceiver for receiving and transmitting a radio interrogation signal. Examples of a suitable RFID chip 106 include the Monza™ RP-6 by Impinj and the Higgs EC IC by Alien, although other suitable passive RFID chips can be used.

The integrated circuit of RFID chip 106 is powered by the incoming radio interrogation signal and thus the signal is transmitted at a power-transmission power level, as opposed to signal-only power level. Due to radio frequency power transmission regulations in the United States and Europe, power-transmission level power is limited to 30 decibels for human exposure and 33 decibels for non-human exposure. For passive RFID chips configured for UHF bandwidths, these power transmission limitations can otherwise limit the overall amount of power that can be transferred to the RFID chip 106. This limitation is one reason why lower frequency systems have been used in conventional animal RFID tag implants; however, lower frequency systems are inherently limited in the read rate for reading and distinguishing among different RFID tags in a common area.

In embodiments, matching circuit 110 can comprise a variety of passive matching components such as resistors, inductors, and capacitors. When RFID chip 106 and antenna 110 are assembled to form RFID tag 100, there is a resultant complex impedance. Matching circuit 110 is configured to match the resultant complex impedance of RFID chip 106 and antenna 110, together with any additional impedance, capacitance or inductance values that may be introduced by the inductor(s) or SMD chip(s) as well as the ionic encasement 130 and the solder joints for solder pads 108 and 114, as well as soldered ends 118. In embodiments, the values for matching circuit 110 are selected to maximize the power transfer of reception/transmission for the passive RFID chip 106 such that a read distance between an RFID reader (not shown) and the RFID tag 100 as implanted in the animal is optimized as described in further detail below.

In some embodiments, antenna 110 is arranged in a closed-loop, folded dipole antenna configuration, Antenna 110 includes a lower portion arranged on second surface 104 and an upper portion arranged on first surface 103. Antenna 110 may comprise printable copper layers or layers formed of other printable or depositable electrically conductive materials. In embodiments, antenna 110 is not formed of any ferrous metals such that RFID tag 100 is magnetic resonance imaging (MRI) compatible. In embodiments, antenna 110 creates a closed-loop, folded dipole antenna configuration by coupling the lower portion of antenna 110 to the upper portion of antenna 110 at each end of substrate 102 via solder joints 118. In this embodiment, antenna 110 effectively wraps around flexible substrate 102 lengthwise.

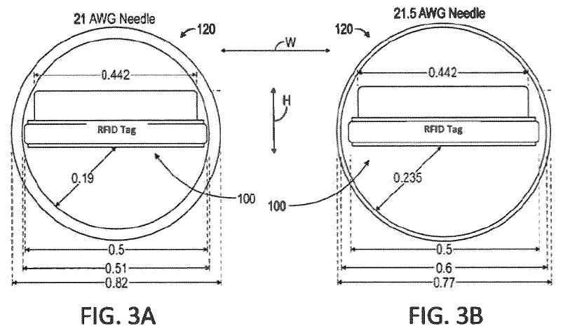

Referring to FIG. 3A and FIG. 3B, RFID tag 100 is configured for implantation in a tail of a rodent by use of a needle 120. Needle 120 is configured for loading and delivery of the RFID tag 100. In embodiments, needle 120 can include a 20-22 AWG gauge needle with a relatively small diameter lumen. In embodiments, needle 120 has a thin-walled tubular or cannula like structure that facilitates an increased inner diameter relative to the desired outer diameter optimized for needle insertion of the RFID tag 100 without the need to use sutures, glue or the like to close the opening in the skin made by needle 102. In embodiments, a thickness of the tubular wall of needle 120 has dimensions ranging from 0.1-0.5 mm,

As shown by the various dimensions in mm in FIG. 3A and FIG. 3B, RFID tag 100 is sized and shaped to be delivered via a relatively small diameter lumen of needle 120. In embodiments, flexible substrate 102, RFID chip 106, antenna 110, and matching circuit 112 have a total combined width of the RFID tag 100 of less than 1 mm and a total combined height of RFID tag 100, which includes the stacked thicknesses of flexible substrate 106, RFID chip 108 or matching circuit 110, and two thicknesses of antenna 112 and ionic encasement 130, is less than 1 mm.

In other embodiments, antenna 110 may be other styles of antennas any form of a conductive material that covers portions of one or both the upper surface 104 and lower surface 103 of flexible substrate 102. In these embodiments, the antenna 110 may be adhered to the flexible substrate 102 or may be deposited onto the flexible substrate 102 by vapor deposition or the like.

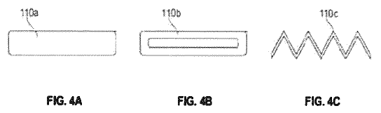

Various embodiments of one or more antenna layers 122, 124 of antenna 110, as depicted in FIGS. 4A-4C, can also be used to vary the RFID system frequency used, or to enhance read distance. It will be understood that various combinations of these antenna layer designs may be used for all of part of one or both antenna layers 122, 124 of antenna 110,

FIG. 4A depicts an embodiment of the RFID tag 100 having a layer 122, 124 of antenna 110a comprises a solid width of copper or conductive material that is substantially equal to a width of substrate 102. This embodiment can be printed on substrate 102 and provides ample surface area for connecting to solder pads 108, 114.

FIG. 4B depicts an embodiment of in which a layer of antenna 1126 comprising a split antenna design having two strips of copper or conductive material separated by a central channel. The central channel creates portions of antenna 1126 having two conduits, instead of one, As antenna 1126 includes two conduits in some portions, the effective length of antenna 1126 may be increased without increasing the actual physical length of RFID tag 100 due to a resonating effect of the two parallel conduits,

FIG. 4C depicts an embodiment of in which a layer 122, 124 of antenna 112c comprises a relatively thin, meandering strip of copper or conductive material conduit. The meandering conduit of antenna 112c may increase the antenna length without increasing the actual physical length of RFID tag 100.

Matching circuits 110 can be arranged in a variety of different physical arrangements on the different surfaces, as well as different variations of circuit components.

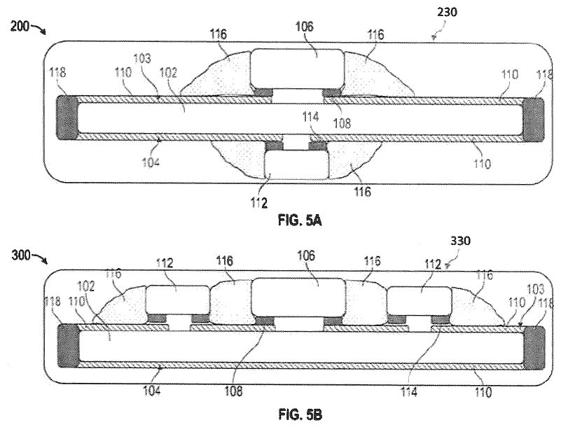

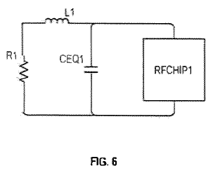

As depicted in FIG. 5A, an embodiment of RFID tag 200, includes matching circuit 110 arranged on second surface 104, instead of first surface 103. In this embodiment, matching circuit 110 is arranged such that it bisects antenna lower layer 124 on the lower, second surface 104. In embodiments, adhesive material 116 is applied as generally indicated on one or both first surface 103 and second surface 104 and ionic encasement 230 may be either fully encapsulating (as shown) or encasing only portions of RFID tag 200.

As depicted in FIG. 5B, an embodiment of RFID tag 300, includes a pair of matching circuits 110 arranged on first surface 103. In embodiments, the matching circuits 110 are positioned symmetrically about the RFID chip 106. In embodiments, adhesive material 116 is applied as generally indicated on the first surface 103 in FIG. 4B, with no adhesive material needed on the second surface 104 and ionic encasement 330 may be either fully encapsulating (as shown) or encasing only portions of RFID tag 300. In embodiments, the corresponding matching circuit gaps 129 in the upper layer 122 of antenna 110 may be arranged to further facilitate the flexibility of the RFID tag.

FIG. 6 illustrates an idealized electrical schematic for a matching circuit 112 in accordance with various embodiment. The Thevenin equivalent for the matching circuit can includes an inductor L1, resistor R1 and equivalent capacitance CEQ1 that represents the net capacitance of the physical and electrical configuration of the various components and connections for RFID tag 100. The matching circuit 112 is configured to match the complex impedance of RFID chip 106 (RFchip1) and antenna 110, including the impact on complex impedance of the ionic encasement 130. Inductor L1 includes the equivalent inductance of the matching circuit as well as any residual inductance created by antenna 110. Resistor R1 includes the equivalent resistance of the matching circuit 112, as well as any residual resistance created by antenna 110, including the impact on complex impedance of the ionic encasement 130. Likewise, capacitance CEQ1 includes the equivalent capacitance of the matching circuit 112, as well as any residual capacitance created by antenna 110, including the impact on complex impedance of the ionic encasement 130. Matching circuit 112, as it is shown in FIG. 6 is configured to optimally match the complex impedance of RFID chip 106 and antenna 110 such that power transfer is optimized. Due to various cost and manufacturing limitations, matching circuits for RFID tag 100 can be varied and still achieve significant power transfer optimization.

In embodiments, the antenna 110 should have an impedance that matches the conjugate of the impedance calculated from the circuit model in FIG. 6 where the values of parameters are provided in a specification datasheet of the RFID chip 106.

$${C}_{mount} = 0.21 pF , {C}_{p} = 1.23 pF , {R}_{p} = 1.2 k Ω \qquad ( Eq . 1 )$$

In this example, the impedance of the antenna expected by the chip is calculated considering the frequency of operation is at 915 Mhz, which is the center frequency of the US ISM UHF band. Because the capacitors in this configuration are in parallel,

$${C}_{total} = {C}_{p} + {C}_{mount} \qquad ( Eq . 2 )$$

Considering the angular frequency and capacitive reactance, the imaginary resistance component is determined as:

$$\begin{matrix}1.44 pF ω = 2 π f ω \\ = 2 \times π \times 915 \times {10}^{6} \\ = 5.749114556069 \times {10}^{9} rad / sXc \\ {=}^{1} j ω C total \\ {=}^{1} - 1.25749114556069 \times {10}^{11} \times 1.44 \times 10 \times j \\ = - 120.7915 j Ω\end{matrix} \qquad ( Eq . 3 )$$

Thus, the Resistance,

$$\begin{matrix}{X}_{R} = Rp \\ = 1.2 k Ω 1 \\ = 1 + 1 {ZX}_{R} {X}_{CZ} \\ = {X}_{R} {X}_{C} {X}_{R} + {X}_{C} \\ = 12.03687 - 119.5799 j Ω\end{matrix} \qquad ( Eq . 4 )$$

Therefore, in this example the equivalent theoretical impedance at the chip is 12.03687-119.5799j Ω where, to match the chip impedance, the antenna must satisfy an impedance equivalent of the total equivalent impedance, which is inductive. The antenna resistance, and the antenna inductance,

$${R}_{A} {L}_{A} = {X}_{R} = 12.03687 Ω = {X}_{L} \qquad ( Eq . 5 )$$

$$Ω = 119.5799 5.749114556069 \times {10}^{9}$$

$$12.03687 + 119.5799 j Ω - Eq . ( 1 ) = 20.8 nH$$

Thus, the matching circuit 112 can be configured to generally match the inductive reactance required by the chip calculated above, by using an inductor with an inductance of 20 nH.

In some embodiments, all, or portions of RFID tag 100 is coated in a protective dielectric coating such as acrylic or chemical vapor deposited polymers prior to encasement of RFID tag 100 with ionic encasement 130. In embodiments, the thickness of the protective coating is important. Enough protective coating is needed to protect RFID chip 100, but the RF transmission and emission qualities can be negatively affected by a protective coating that is too thick. For example, a target Parylene C™ thickness could be between 7.5 μm to 25 μm. In some embodiments, an adhesive material 116, such as a Dymax™, can be placed over RFID chip 106 and matching circuit 112 to smooth edges of RFID chip 106 and matching circuit 112. The smoothed edges ease insertion of RFID tag 100 and reduce wearing against the tissue of the animal. In some embodiments, the portions of RFID chip 100 coated with protective coating do not include areas above the antenna 110 such that ionic encasement 130 is in electrical contact with the antenna 110.

In use, RFID tag 100 is configured for insertion into an animal, such as in a tail of a rodent. via needle 120. In some embodiments, RFID tag 100 can be placed within an upper half of the rodent's tail medial to the dermis and hair follicles but lateral to the bone, tendons, and muscles. In this position, the physiology of the rodent is relatively unhindered. Further, the flexibility of flexible substrate 102 allows RFID tag 100 to move with the rodent's tail as opposed to restricting the same movement.

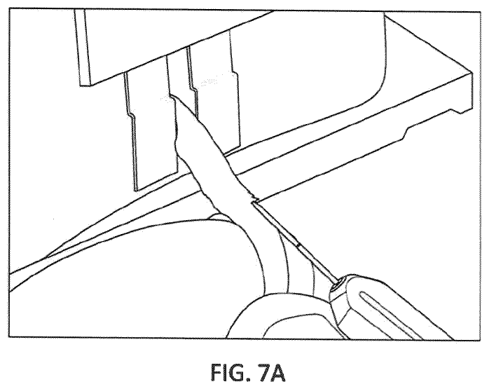

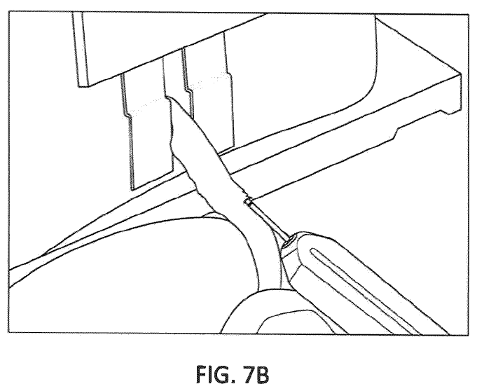

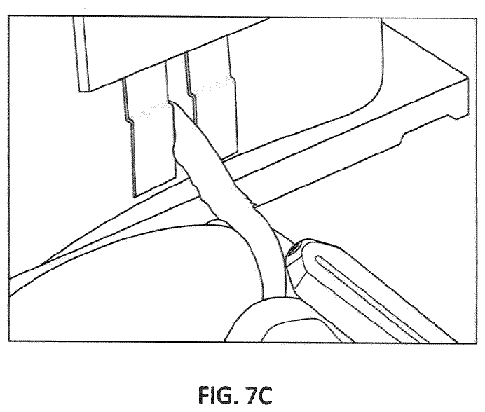

In one embodiment the sequence for manual needle implantation of RFID tag 100 is shown in FIGS. 7A-7C. A tag injector with a 20-22 AWG needle 120 into which the RFID tag 100 is positioned is inserted into the tail of a rodent which is restrained. In embodiments, the needle includes a user-visible mark or indication at a distance about 1.5 times the length of the RFID tag 100 from the distal tip of the needle 120 as a guide for how far the user should insert the needle. In one embodiment for an RFID tag having a length of 6 mm, the mark is located 9 mm from the distal tip of the needle 120. In embodiments, the mark may be printed, embossed, or etched on the exterior of the needle. In embodiments, the tag injector includes a stop or other structure to temporarily hold the RFID tag 100 in the implanted position within the upper half of the rodent's tail medial to the dermis and hair follicles but lateral to the bone, tendons, and muscles while the needle 120 is withdrawn.

Various embodiments of aspects of the disclosure are described further detail in U.S. Pat. Nos. 11,240,992, 11,330,798, 11,392,816, each of which is hereby incorporated by reference.

Various embodiments of aspects of the disclosure are described in U.S. Provisional Patent Appl, 63/359,637, the disclosure of which is hereby incorporated by reference.

Persons of ordinary skill in the relevant arts will recognize that embodiments may comprise fewer features than illustrated in any individual embodiment described above. The embodiments described herein are not meant to be an exhaustive presentation of the ways in which the various features of the embodiments may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

1. An improved passive micro-RFID tag comprising:
an elongated flexible substrate having a pair of opposed surfaces;
an RFID chip positioned on a first of the opposed surfaces and responsive to radio frequencies;
an antenna directly electrically connected to the RFID chip and disposed on at least one of the opposed surfaces of the substrate;
an antenna matching circuit electrically connected to the antenna; and
an ionic encasement surrounding at least a portion of the micro-RFID tag and having a maximum thickness of 0.1 mm to 1.0 mm;
such that the micro-RFID tag has maximum dimensions of 2.5 mm wide and 12 mm long and can be read with at least 90 percent effectiveness by a 30 dB RFID tag reader at a read-distance-to-size ratio of at least 4,000:1.

2. The improved passive micro-RFID tag of claim 1, wherein the ionic encasement, formed of a non-biologic medium in the form of one or more of a conductive ionic polymer, a conductive ionic gel, or a combination thereof.

3. The improved passive micro-RFID tag of claim 1, further comprising an insulative coating having a maximum thickness of 50 μm disposed between portions of the micro-RFID tag and the ionic encasement other than at portions above the antenna.

4. The improved passive micro-RFID tag of claim 1, wherein the RFID chip is secured to the first of the opposed surfaces by both solder pads under the RFID chip and an ultraviolet adhesive on top of at least a portion of the RFID chip, and wherein the elongated flexible substrate is configured to form a curved arc between the pair of opposed ends of the substrate up to a 45 degree arc angle with less than a ten percent failure rate of the RFID tag.

5. The improved passive micro-RFID tag of claim 1, wherein the antenna matching circuit includes an inductor is part of the antenna matching circuit that has an equivalent resistance of less than 50 ohms electrically connected to the antenna.

6. The improved passive micro-RFID tag of claim 1, wherein the elongated flexible substrate is a strip of polyimide material with a pair of opposed ends and having a maximum thickness of 100 μm and a dielectric constant in the range of 2.75-3.5.

7. The improved passive micro-RFID tag of claim 1, wherein the antenna is a closed-loop multi-layer folded dipole antenna formed of a layer of copper deposited on each of the pair of opposed surfaces with an end of each layer proximate one of the pair of opposed ends of the strip soldered together and terminated to form an electrical connection between the layers of copper on the pair opposed surfaces.

8. The improved passive micro-RFID tag of claim 1, wherein the RFID chip is configured for an ultra-high frequency and the antenna matching circuit includes an inductor having an inductance of 5-50 nH.

9. The improved passive micro-RFID tag of claim 2, wherein the ionic encasement is formed of a polymer matrix injected with an ionic conductive hydrogel.

10. The improved passive micro-RFID tag of claim 9, wherein the polymer matrix is a 3D printed thermoplastic polyurethane polyurethane (TPU) frame, and the ionic conductive hydrogel is a polyacrylamide (PA Am) based hydrogel.

11. (canceled)

12. An improved passive RFID tag comprising:
an elongated flexible substrate having a pair of opposed surfaces;
an RFID chip positioned on a first of the pair of opposed surfaces and responsive to radio frequencies;
an antenna directly electrically connected to the RFID chip and disposed on at least one of the pair of opposed surfaces of the substrate;
an antenna matching circuit electrically connected to the antenna; and
an ionic encasement surrounding at least a portion of the RFID tag and having a maximum thickness of 0.1 mm to 1.0 mm;
such that the RFID tag can be read with at least 90 percent effectiveness by a 30 dB RFID tag reader at a read-distance-to-size ratio of at least 5,000:1 for a minimum read distance of 50 cm and a minimum size of 10 mm.
